(19) United States
(12) Patent Application Publication
(10) Pub. No.: US 2012/0160724 A1
(43) Pub. Date: Jun. 28, 2012

(54) PACKAGE FOR PHARMACEUTICAL PRODUCTS WITH MEANS FOR ALLOWING INTERNAL BAR CODES TO BE SCANNED

(75) Inventor: John A. Gelardi, Midlothian, VA (US)

(73) Assignee: MEADWESTVACO CORPORATION, Richmond, VA (US)

(21) Appl. No.: 13/394,200

(22) PCT Filed: Sep. 30, 2010
(86) PCT No.: PCT/US10/50905

§ 371 Date: Mar. 5, 2012

Related U.S. Application Data
(60) Provisional application No. 61/247,041, filed on Sep. 30, 2009.

(51) Int. Cl. A61J 1/00; B65D 50/00; B65D 5/42

(52) U.S. Cl. 206/438; 206/459.5

(57) ABSTRACT

Disclosed is an outer package (10) for containing an inner package (20) that is marked on its surface with a bar code (25). The outer package includes a cut out area (15) on its surface. The bar code marked on the inner package is displayed through the cut out area of the outer package when the inner package is completely inserted into the outer package. The outer package can be made of a hard plastic shell or a paperboard container. The inner package can be a blister pack or a box small enough to fit within the outer package.

This non-provisional application relies on the filing date of provisional U.S. Application Ser. No. 61/247,041, filed on Sep. 30, 2009, having been filed within twelve (12) months thereof, which is incorporated herein by reference, and priority thereto is claimed under 35 USC §1.19(e).

### BACKGROUND OF THE INVENTION

Many pharmaceutical products are dispensed in packaging that includes a blister pack. This is true for both over the counter and prescription medications. Typically the blister pack is housed within a paperboard or plastic shell. The consumer exposes the blister pack from its housing and then accesses one or more of the individual doses contained thereon.

From a quality control standpoint, manufacturers prefer to bar code the blister packs as opposed to the outer packaging to ensure that the medication or product associated with the blister pack is accurately labeled. The outer packaging can typically accommodate a variety of different blister packs. Bar coding the outer packaging does not ensure that the blister packs are properly labeled. It is possible to insert the wrong batch of blister packs into outer packaging that is bar coded for a different product.

Heretofore, quality control required that the blister pack be unlocked from its outer packaging, removed to expose the bar code label, scanned to verify the proper contents and re-inserted into the outer packaging. This is a very inefficient and time consuming process to ensure quality control.

What is needed is a more efficient and faster process for performing quality control checks that ensure the contents (blister pack) match the labeling on the outer packaging.

### SUMMARY OF THE INVENTION

Disclosed is an outer package for containing an inner package that is marked on its surface with a bar code. The outer package includes one or more cut out areas on its surface. The cut out area may be a window or may be covered by a transparent material such that the bar code is visible/scanable through such material. The bar code marked on the inner package is displayed through the one or more cut out/transparent area of the outer package when the inner package is completely inserted or locked into the outer package. In one embodiment, the outer package can be made of a hard plastic shell. In another embodiment, the outer package can be made of a paperboard container. In yet another embodiment, the outer package, paper or plastic, may have child resistant features. The inner package displaying the bar code can be a blister pack, tray, pouch and/or a box small enough to fit within the outer package. Information besides a bar code may be printed on the inner package and displayed through the one or more cut out or transparent area. Such information may include patient name, drug name, dosage instructions, brand name, whether the package is locked and/or date.

### BRIEF DESCRIPTION OF THE DRAWINGS

FIG. 1 is an illustration of a plastic shell outer packaging containing a blister pack with bar code labeling showing through a cut out area of the outer packaging.

FIG. 2 is an illustration of a plastic shell outer packaging of FIG. 1 with the blister pack partially removed showing the bar code labeling.

FIG. 3 is an illustration of a paperboard outer packaging containing a blister pack with bar code labeling showing through a cut out area of the outer packaging.

FIG. 4 is an illustration of a paperboard outer packaging of FIG. 3 with the blister pack partially removed showing the bar code labeling.

FIG. 5 is an illustration of an outer package and inner blister combination showing two viewing areas one for the barcode and/or additional patient or package information and one for a second set of data such as package status.

FIG. 6 is an illustration of an outer clam shell package and inner blister combination showing a cutout in the outer shell positioned to allow scanning or viewing of information printed on the blister.

FIG. 7 is an illustration of a snap shut outer package and inner blister combination showing a cutout in the outer cover positioned to allow scanning and/or viewing of the information printed on an inner portion of the package.

FIG. 8 is an illustration of a multi-blister package with an outer shell and multiple blisters showing a cutout in the outer shell positioned to allow scanning or viewing of information printed on the blister.

FIG. 9 is an illustration of a multi-blister package with an outer shell and multiple blisters in an open configuration showing a cutout in the outer shell positioned to allow scanning or viewing of information printed on the blister.

FIG. 10 is an illustration of a multi-blister package with an outer shell and multiple blisters showing a cutout in the outer shell positioned to allow scanning or viewing of information printed on the blister.

FIG. 11 is an illustration of a multi-blister package with an outer shell and multiple blisters in an open configuration showing a cutout in the outer shell positioned to allow scanning or viewing of information printed on the blister.

FIG. 12 illustrates a multi-blister package with an outer shell and multiple inner blisters or trays in a closed configuration and having a cut out area aligned with a portion of printed information on the blisters.

FIG. 13 illustrates a multi-blister package in an open configuration.

FIG. 14 illustrates a blown out view of the pieces of the multi-blister package showing the multiple cut out openings in the top and bottom pieces of the outer shell and the information aligned on the inner blisters.

FIGS. 15-17 illustrate clear outer packages transparent such that the printed material on the inner blisters or trays is visible in a closed position.

### DETAILED DESCRIPTION OF THE PREFERRED EMBODIMENTS

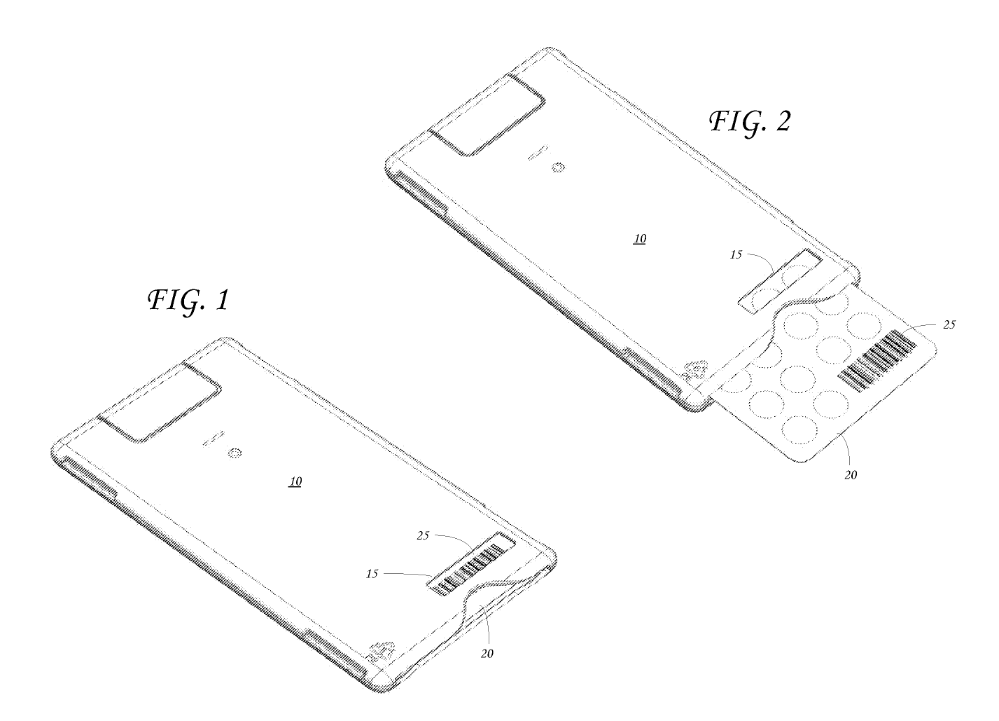

FIG. 1 is an illustration of a plastic shell outer packaging 10 containing a blister pack 20 with bar code labeling 25 showing through a cut out area 15 of the outer packaging 10. The plastic outer packaging 10 includes a cut out area 15 positioned somewhere on the surface of the plastic shell outer packaging 10. The purpose of cut out area 15 is to expose the bar code labeling 25 printed on blister pack 20 that is contained within the plastic shell outer packaging 10. The size and location of cut out area 15 is variable and its depiction in the Figures is merely exemplary.

FIG. 2 is an illustration of a plastic shell outer packaging 10 of FIG. 1 with the blister pack 20 partially removed showing the bar code labeling 25.

By lining up the bar code labeling 25 on the blister pack 20 with the cut out area 15 of the outer packaging 10, the entire package solution can be scanned for identification/verification without having to unlock and remove the blister pack 20 from its outer packaging 10. This is a significant advancement in efficiency and accuracy for quality control purposes. Moreover, the entire package solution can be shrink-wrapped and still allow for bar code scanning so long as the shrink wrap material is relatively transparent. This adds another level of efficiency to the process.

Other features of the plastic shell packaging are not described herein as they are the subject of other co-pending applications assigned to a common assignee. This includes features relating to child resistance and senior friendliness. Only the features relevant to the present invention have been labeled and described in the present disclosure. It is to be understood that a variety of child resistant and/or senior friendly features may be utilized in any of these shell/blister combinations in addition to the cut out area. Some of the child resistant features may include one or more release buttons positioned on the top, bottom and or sides. Other child resistant features may include a locking mechanism such as a lip or ledge for the blister or internal tray to catch on. Key like features requiring a small device to lower the blister to slide past the locking mechanism may be included as well. A second portion of the locking mechanism may include a portion of the package pushing the blister or internal tray upwards against the first portion of the locking mechanism. Examples of similar child resistant features have been disclosed in U.S. Pat. Nos. 7,591,372 and 6,047,829.

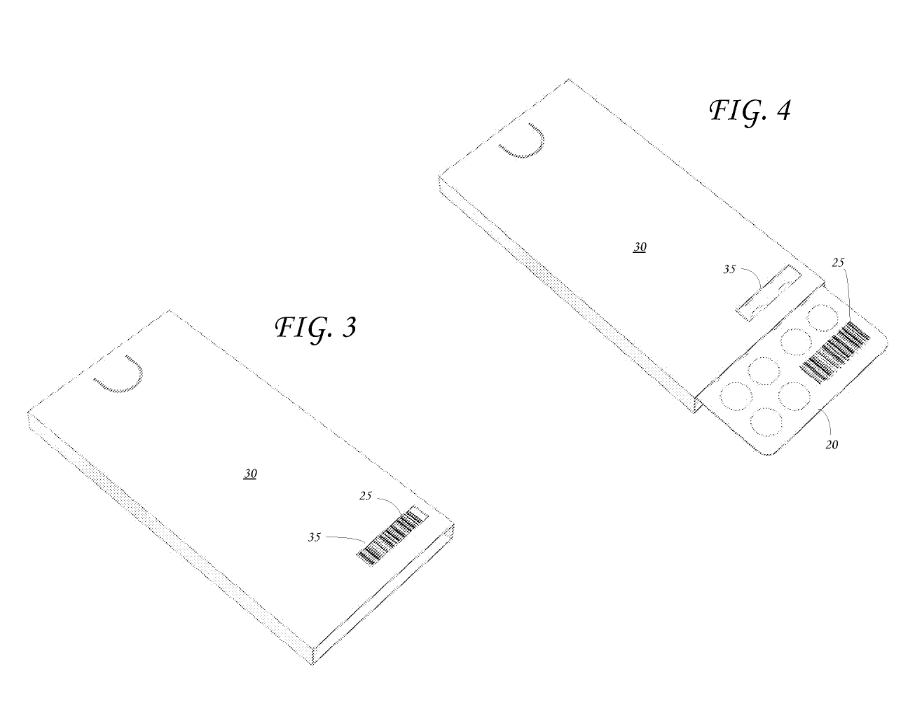

FIG. 3 is an illustration of a paperboard outer packaging 30 containing a blister pack 20 with bar code labeling 25 showing through a cut out area 35 of the outer packaging 30. The paperboard outer packaging 30 includes a cut out area 35 positioned somewhere on the surface of the paperboard outer packaging 30. The purpose of cut out area 35 is to expose the bar code labeling 25 printed on blister pack 20 that is contained within the paperboard outer packaging 30. The size and location of cut out area 35 is variable and its depiction in the Figures is merely exemplary.

FIG. 4 is an illustration of a paperboard outer packaging of FIG. 3 with the blister pack 20 partially removed showing the bar code labeling 25.

By lining up the bar code labeling 25 on the blister pack 20 with the cut out area 35 of the outer packaging 30, the entire package solution can be scanned for identification/verification without having to unlock and remove the blister pack 20 from its outer packaging 30. This is a significant advancement in efficiency and accuracy for quality control purposes. Moreover, the entire package solution can be shrink-wrapped and still allow for bar code scanning so long as the shrink wrap material is relatively transparent. This adds another level of efficiency to the process.

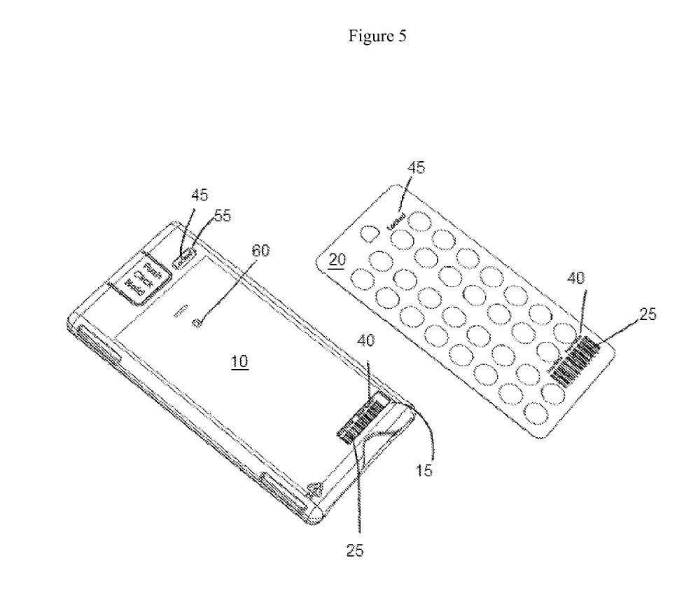

FIG. 5 is an illustration of an outer paperboard or plastic package and an inner blister card showing two cut out areas, 15 and 55. The information to be printed on the inner package or blister 20 may be the bar code 25 and/or patient name, drug name, brand name, date etc . . . 40. In addition a separate cut out area 55 may be used to show additional information such as Locked 45 or a color to show which patient in a family of patients the medication belongs to, or patient name, drug name, brand name, date or other such information as so desired. It is understood that other product information may be displayed through the cut out opening 15 for example, date, patient name, drug name, dosage instructions, brand name, color indicator, package status indicator (open/closed etc) or other such information. One or more cut out areas 15 may be present in outer package 10. The cut out area 15 may be covered with a transparent film or other such material such that the inner product container or blister 20 may not be touched by the consumer through that opening. It is to be further understood that an entirely transparent outer package 10 may be used and a bar code 25 placed on the inner product container 20 such that the bar code or other information is scanable or readable. One or more inner packages may be contained within a single outer package. If an interior component is used to stack the inner packages together it is to be understood that product information could be printed on that component in addition or instead of the inner package itself. Stickers or other such materials displaying product information may be affixed to the product package or other interior components.

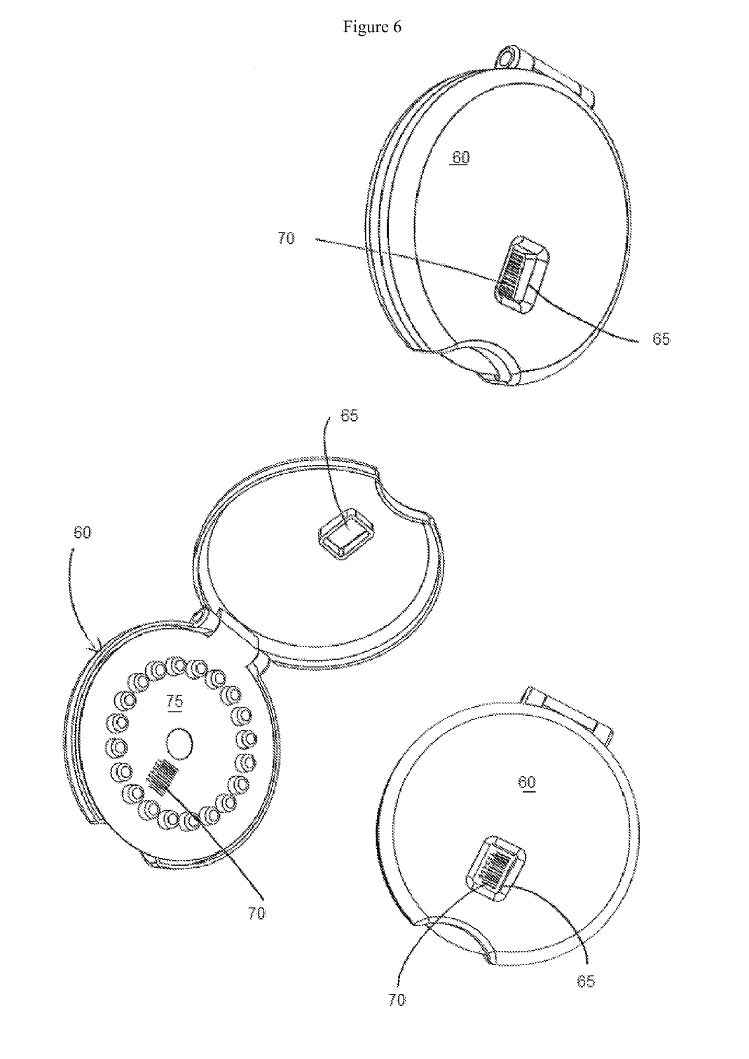

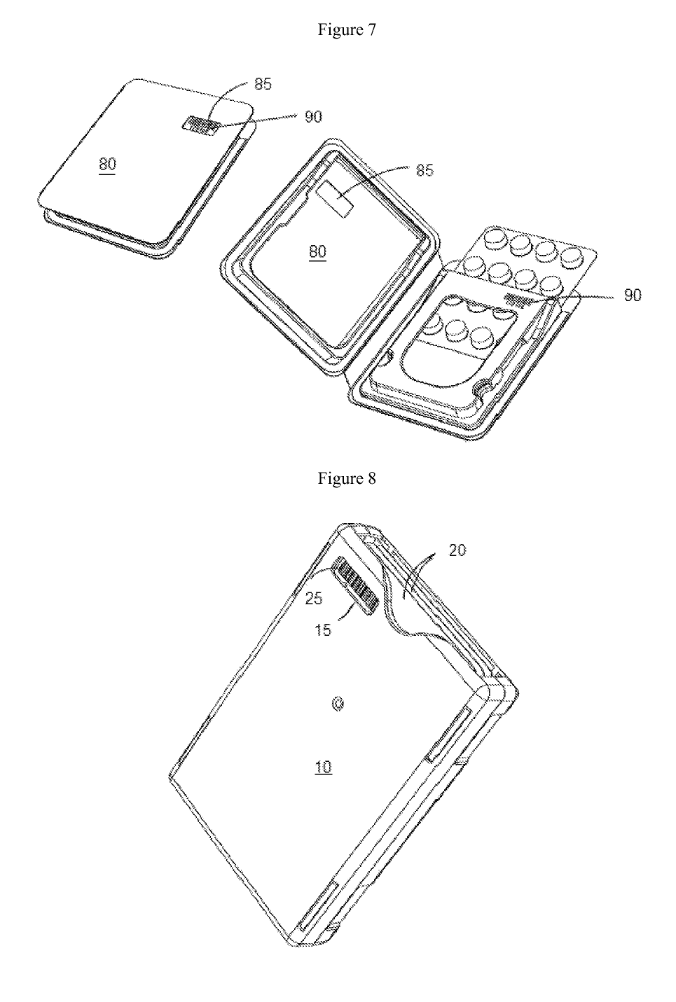

FIG. 6 shows a clam shell package style in a rounded shape. The outer shell 60 snaps together. One or more side of the outer shell 60 may have one or more cut out areas 65 allowing viewability of information 70 printed on the inner card or tray 75. It is to be understood that this information 70 may be a bar code, patient name or any of the other varieties of information listed herein. In addition it is to be understood that there may be multiple cut out areas displaying information printed on the blister card. FIG. 7 is a similar package showing another snap shut design but in a rectangular shape. It is to be understood that other geometric shapes may be used for the package 80. The important feature whatever the package shape is the alignment of the viewing cut out with the information. In FIG. 7 the information 90 is printed on a portion of the inner package and viewable when the package is in a closed position through cut out 85. It is to be understood that cut out 85 may be positioned so that it is aligned with information 90 printed on the blister or tray rather than the inner package.

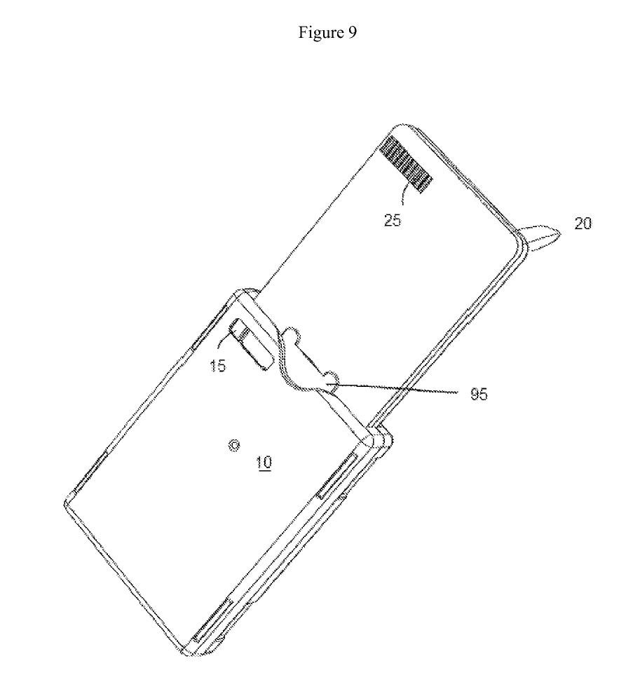

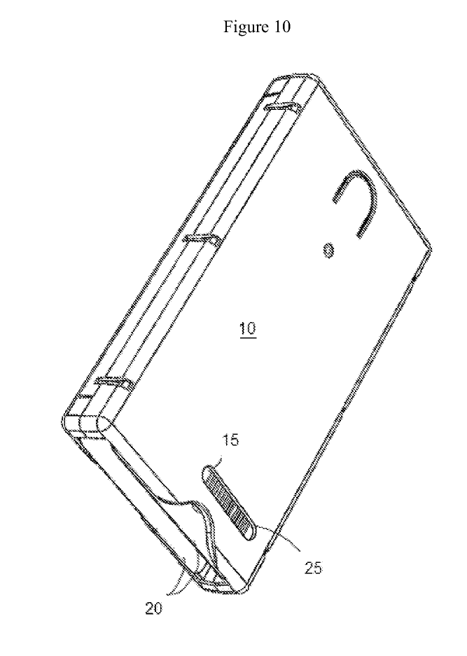

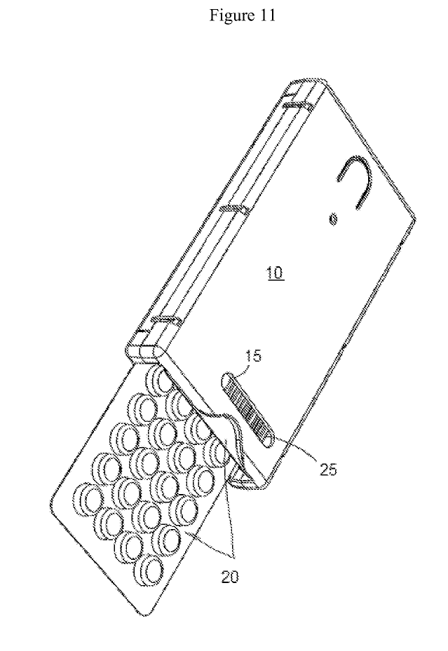

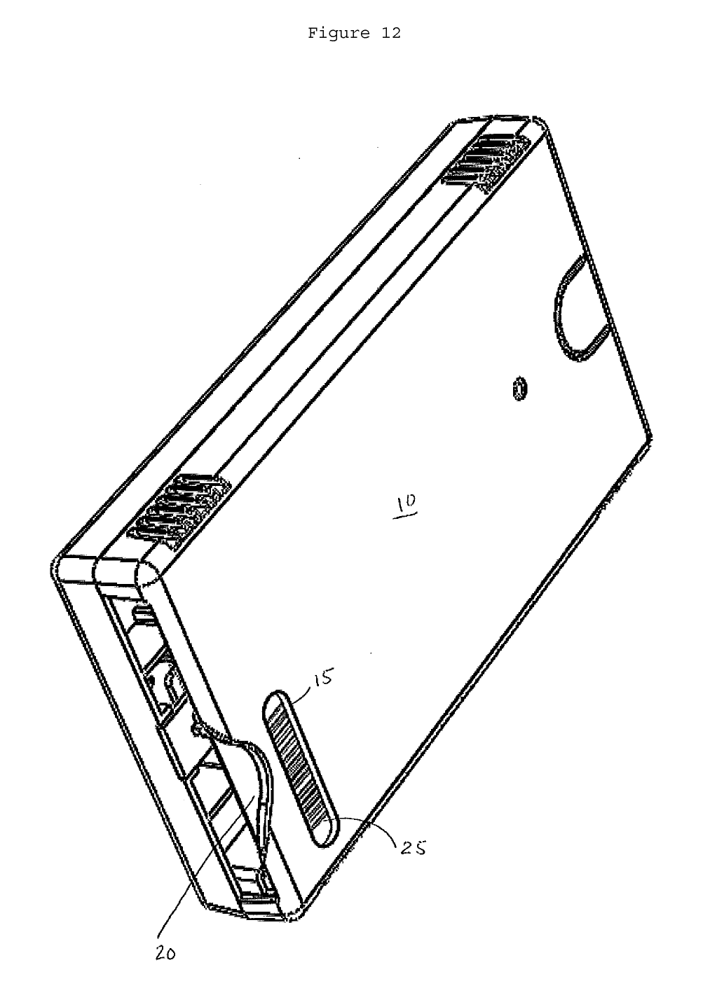

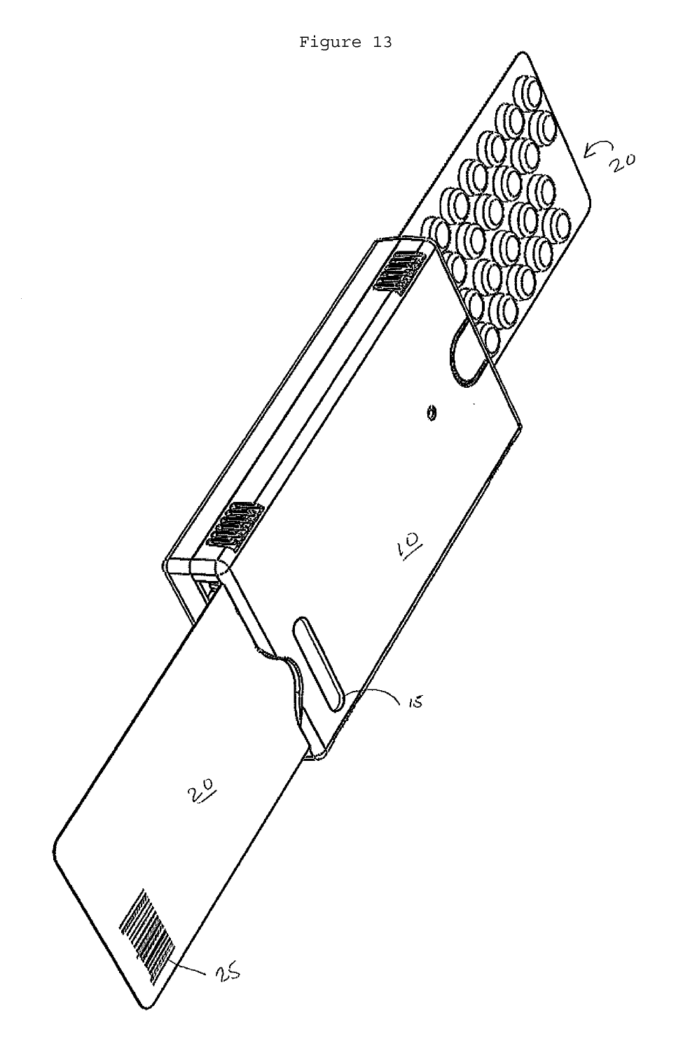

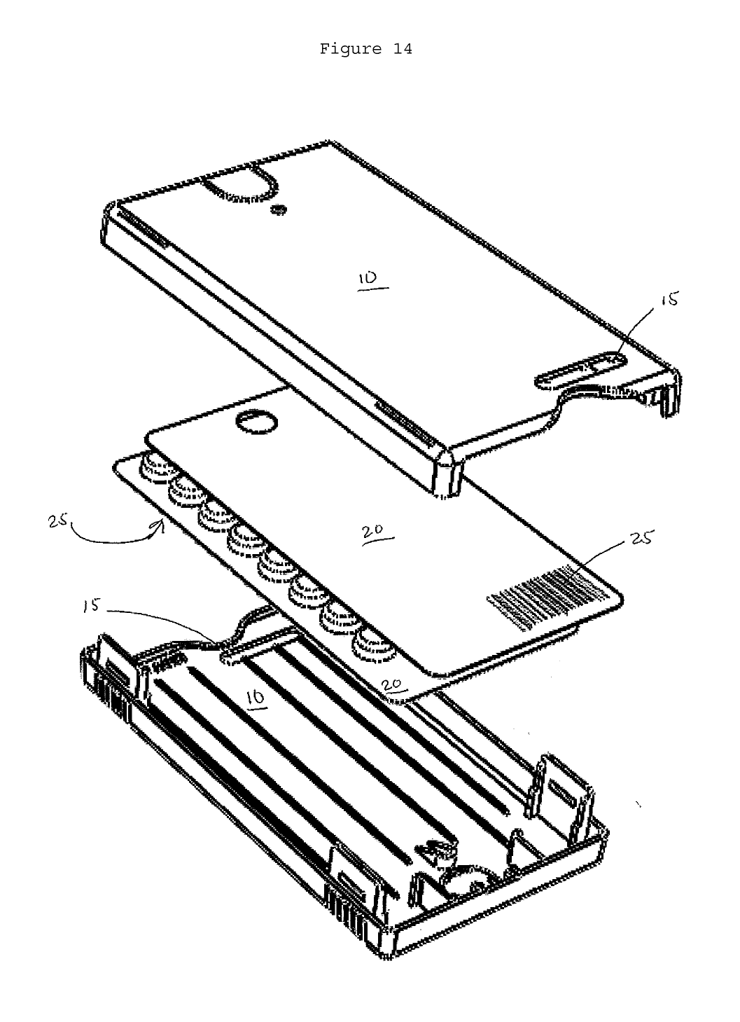

FIGS. 8-14 illustrate multi-blister packages. The outer sleeve 10 houses multiple blister or trays 20. In FIGS. 8 and 9 the blisters are connected on a traveler or sled 95 which once the blisters and or trays 20 are placed on the traveler 95 moves them in unison in and out of the sleeve 10. The information 25 may be printed on one or more of the blisters or trays 20. One or more pieces of information 25 may be placed on the traveler 95 and the one or more corresponding cut outs 15 on the outer shell 10 may be aligned with such information 25. FIGS. 10 and 11 shows a multi blister pack that allows the inner blisters or trays 20 to move independently of one another within the outer shell 10. The information 25 may be printed on one or more blisters or trays 20 and one or more side of the outer package 10 may have one or more cutouts 15 such that the information 25 is scanable or viewable when the one or more blisters or trays 20 are in a closed position. FIGS. 12 and 13 also show a multi blister pack, but the inner tray or blisters 20 may be removed in opposite directions from the outer shell 10. To ensure the medication is loaded correctly on both sides of the package it may be beneficial to view the printed information 25 from both sides of the package. Accordingly one or more blisters 20 may have printed information 25 that aligns with a viewable area or cut out 15 such that the pharmacist or patient may confirm that the correct medication or product has been inserted without having to remove the inner card 20. FIG. 14 shows a blown out version of the package of FIG. 12. Outer package 10 has a cut out 15 in both the top and the bottom portions. The one or more inner blister cards or trays 20 have information 25 printed and aligned with cut out openings 15 on the top and bottom of the package.

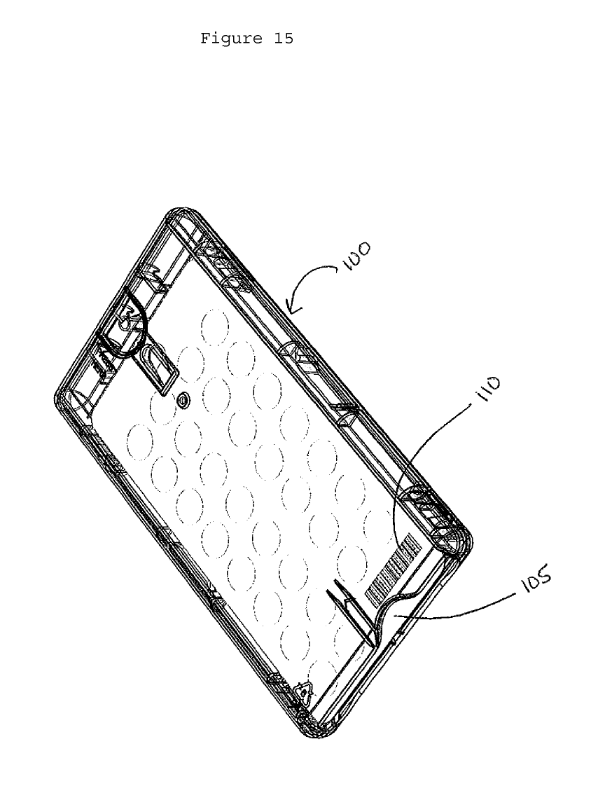

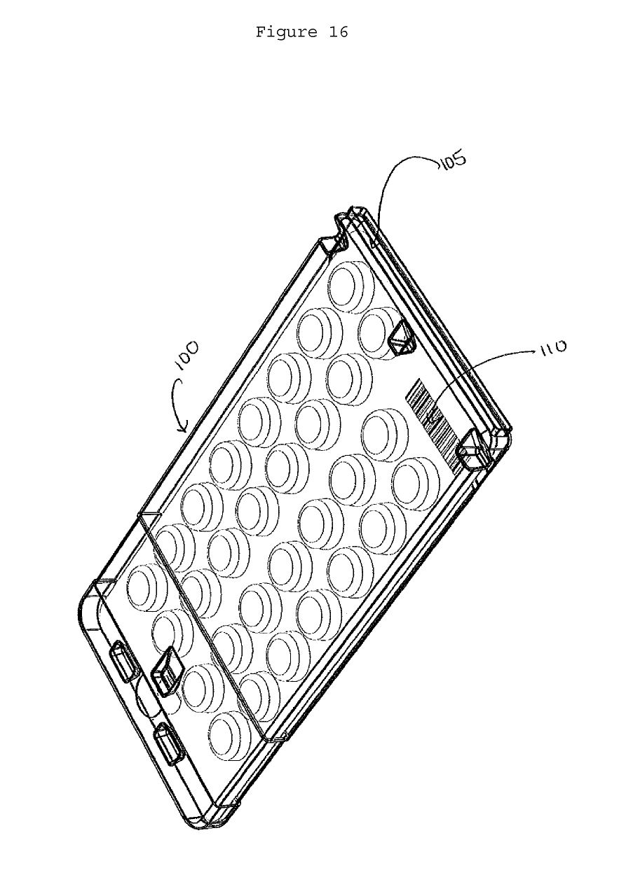

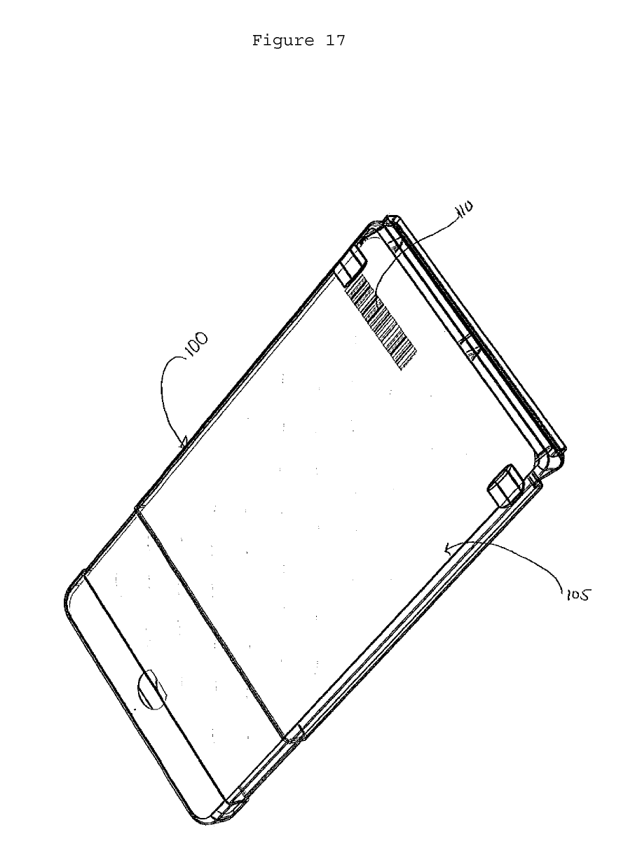

FIGS. 15-17 illustrates a clear see through outer package 100 that allows the printed information 110 to be scanned or viewed will the inner blister or tray 105 is in a closed position. There may be one or more locations of information 110 on the inner blister or tray 10. The clear outer package may be a two piece structure attached together as shown in FIG. 15 or a single piece structure as shown in FIG. 16. An outer shrink wrap film may be provided to give additional protection to the product. The outer shrink wrap film may be colored everywhere but an area aligned over the information 25 to protect the product from possible light denaturing. In these embodiments there is no need for cut out area 15.

It is also to be understood that the outer tray may be of any manufacturable shape or size such as rectangular, oval, octagonal, circular, square or other such geometric or non-geometric shapes. It is to be understood that the inner package will be designed to lock into place and when locked into place the desired information printed on the inner package will be visible through an opening or cutout in the outer package. The outer package may be a clam shell style package or a sleeve style package or any other suitable style package that allows the inner package to be secured inside the outer package. The outer package may be plastic or a plastic-like component such as PET, PLA, APET, RPET or the like, the plastic may have additives added, may be petroleum based or biopolymer based. The outer package may also be paper board, treated or untreated. The outer package 10 may also be wrapped in shrink wrap or other transparent material which may or may not cover and protect the one or more cut out opening areas. In addition stickers or clear transparent film may be placed over the cut out areas. Such material may be protective to reduce any denaturing of the drug or other such product. The outer package or shell may have child resistant features or senior friendly features.

The inner package may be a blister. It may be a blister with electrical traces. The inner package may be a tray holding pouches or loose medication or having perforations in the bottom of the tray for added protection of the medication or child resistant features.

Other features of the paperboard packaging are not described herein as they are the subject of other co-pending applications assigned to a common assignee. This includes features relating to child resistance, senior friendliness and outer packages for multiple inner packages or multiple drug containers. Only the features relevant to the present invention have been labeled and described in the present disclosure.

The foregoing disclosure disclosed a blister pack as the type of inner package or insert that is contained by the outer package. While a blister pack is a typical and common type of insert for use with the outer package, it is not necessarily the only type of inner package that can be implemented using the principles of the invention. Other types of inner packages can be imprinted or labeled with bar codes and used in the same fashion as the blister pack. Thus, the present invention is not limited to blister packs as the only inner package option. Other inner packages can include, but are not limited to, covered trays or boxes that are small enough to fit within the outer package or pouches. It is to be understood that it may be advantageous to design this inner package holding the product to not be fully removable from the outer shell without harming the structure of the outer package or inner package.

Accordingly, this disclosure should not be read as being limited only to the foregoing examples or only to the designated preferred embodiments.

1. A plastic outer package for containing at least one inner package that is marked on its surface with one or more pieces of product information, the plastic outer package comprising one or more cut out areas on its surface such that the one or more pieces of product information marked on the at least one inner package is displayed through the one or more cut out areas of the plastic outer package when the at least one inner package is fully locked into the plastic outer package.

2. The plastic outer package of claim 1 wherein the one or more pieces of product information is a bar code.

3. The plastic outer package of claim 1 wherein the at least one inner package is a blister pack.

4. The plastic outer package of claim 1 wherein the at least one inner package is a pouch.

5. The plastic outer package of claim 1 wherein the at least one inner package is a tray.

6. The plastic outer package of claim 1 wherein the at least one inner package is a box.

7. The plastic outer package of claim 1 further comprising child resistant features.

8. The plastic outer package of claim 1 wherein the one or more pieces of product information is one or more selected from the group consisting of patient name, drug name, dosage information, date, color, and package status indicator.

9. The plastic outer package of claim 1 wherein the one or more cut out areas comprise two cut out areas.

10. A paperboard outer package for containing at least one inner packages that is marked on its surface with one or more pieces of product information, the paperboard outer package comprising one or more cut out areas on its surface such that at least one of the one or more pieces of product information marked on the at least one inner package is displayed through the one or more cut out areas of the paperboard outer package when the at least one inner package is fully locked into the paperboard outer package.

11. The paperboard outer package of claim 10 wherein the at least one inner package is a blister pack.

12. The paperboard outer package of claim 10 wherein the at least one inner package is a box.

13. The paperboard outer package of claim 10 wherein the at least one inner package is a pouch.

14. The paperboard outer package of claim 10 wherein the at least one inner package is a tray.

15. The paperboard outer package of claim 10 further comprising child resistant features.

16. The paperboard outer package of claim 10 wherein the one or more pieces of product information is one or more selected from the group consisting of patient name, drug name, dosage information, date, color, bar code and package status indicator.

17. (canceled)

18. (canceled)

19. An outer package containing at least one inner packages that is marked on its surface with at least one pieces of product information, the outer package comprising one or more transparent areas on its surface such that the at least one piece of product information marked on the inner package is displayed through the one or more transparent areas of the outer package when the at least one inner package is fully locked into the outer package.

20. The outer package of claim 19 wherein the at least one piece of product information is one or more selected from the group consisting of patient name, drug name, dosage information, date, color, bar code and package status indicator.

21. The outer package of claim 19 wherein at least some part of the outer package is transparent.
